(19) United States
(12) Patent Application Publication
(10) Pub. No.: US 2008/0220827 A1
(43) Pub. Date: Sep. 11, 2008

(54) GENERATOR AND COMMUNICATION DEVICE USING THE SAME

(75) Inventor: Chi-Cheng Lin, Taoyuan (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BENQ CORPORATION, Taipei County (TW)

(21) Appl. No.: 11/933,488

(22) Filed: Nov. 1, 2007

(30) Foreign Application Priority Data
Mar. 6, 2007 (TW) 96107741

(51) Int. Cl. H04M 19/08; H02J 7/14; H02K 7/18

(52) U.S. Cl. 455/573; 320/114; 322/1; 322/9

(57) ABSTRACT

A generator disposed in an electronic device (such as a communication device) capable of vibrating is provided. The generator includes a vibrating motor, an actuating device and a weighting device. The electronic device can be vibrated or temporarily charged by the vibrating motor. The vibrating motor is driven by the actuating device to generate electricity. When the generator is in a first state, the vibrating motor can be driven for generating electricity by the actuating device through the weighting device. When the generator is in a second state, the electronic device is capable of vibrating through the vibrating motor.

This application claims the benefit of Taiwan application Serial No. 96107741, filed Mar. 6, 2007, the subject matter of which is incorporated herein by reference.

### BACKGROUND OF THE INVENTION

1. Field of the Invention

The invention relates in general to a generator and a communication device using the same, and more particularly to a generator disposed in a communication device.

2. Description of the Related Art

The usage time of an electronic device, such as a mobile phone, is determined by the capacity of the battery of the electronic device. Take the mobile phone for example, the usage time of the mobile phone increases due to the development of power saving technology; however, additional functions, such as high transmission speed of video or photographing, increase the requirement of the capacity of the battery. When a user stays outdoors and needs to charge an electronic device such as a mobile phone or a radio, an external charger can be used to temporarily charge the electronic device.

Referring to FIG. 1, a conventional external charger in operation is illustrated. The external charger 10 is electrically connected to an electronic device 20 through a connecting wire 50. Then, mechanical energy is generated by manually turning a handle 11. At this time, the mechanical energy in the external charger 10 is further converted to electrical energy and then transmitted to the electronic device 20 for temporarily charging. Therefore, the external charger 10 can be used to temporarily charge the electronic device 20 when the battery of the electronic device 20 is getting low or in case of emergency, such as a power outage.

However, the external charger and the connecting wire are not the necessaries that a user would carry with anytime. In other words, the external charger needs to be carried additionally. In addition, the external charger occupies large space, so it is not convenient to carry the external charger. Furthermore, the user has to spend extra money buying the external charger and it increases the user's expense.

### SUMMARY OF THE INVENTION

The invention is directed to a generator and a communication device using the same.

According to a first aspect of the present invention, a generator disposed in an electronic device capable of vibrating is provided. The generator includes a vibrating motor, an actuating device and a weighting device. The vibrating motor is for generating electricity or vibrating the electronic device. The actuating device is for driving the vibrating motor to generating electricity. The weighting device includes a first weighting unit and a second weighting unit. The first weighting unit is coupled to the vibrating motor. The second weighting unit is disposed opposite to the first weighting unit and coupled to the actuating device. The second weighting unit is engaged with the first weighting unit when the generator is in a first state, and meanwhile the vibrating motor is driven for generating electricity by the actuating device due to the engagement of the first weighting unit and the second weighing unit. The first weighting unit is separated from the second weighting unit when the generator is in a second state, and meanwhile the electronic device is capable of vibrating through the operation of the first weighting unit driven by the vibrating motor.

According to a second aspect of the present invention, a communication device is provided. The communication device includes a vibrating motor and an actuating device. The vibrating motor is for generating electricity or vibrating the communication device. The actuating device is for driving the vibrating motor to generate electricity. The vibrating motor is driven for generating electricity by the actuating device when the communication device is in a first state, and the vibrating motor is for is for vibrating the communication device when the communication device is in a second state.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates a conventional external charger in operation;

FIG. 2 illustrates a first embodiment of the present invention;

FIG. 3 illustrates the mobile phone in FIG. 2 in the second state; and

FIG. 4 illustrates a second embodiment of the present invention.

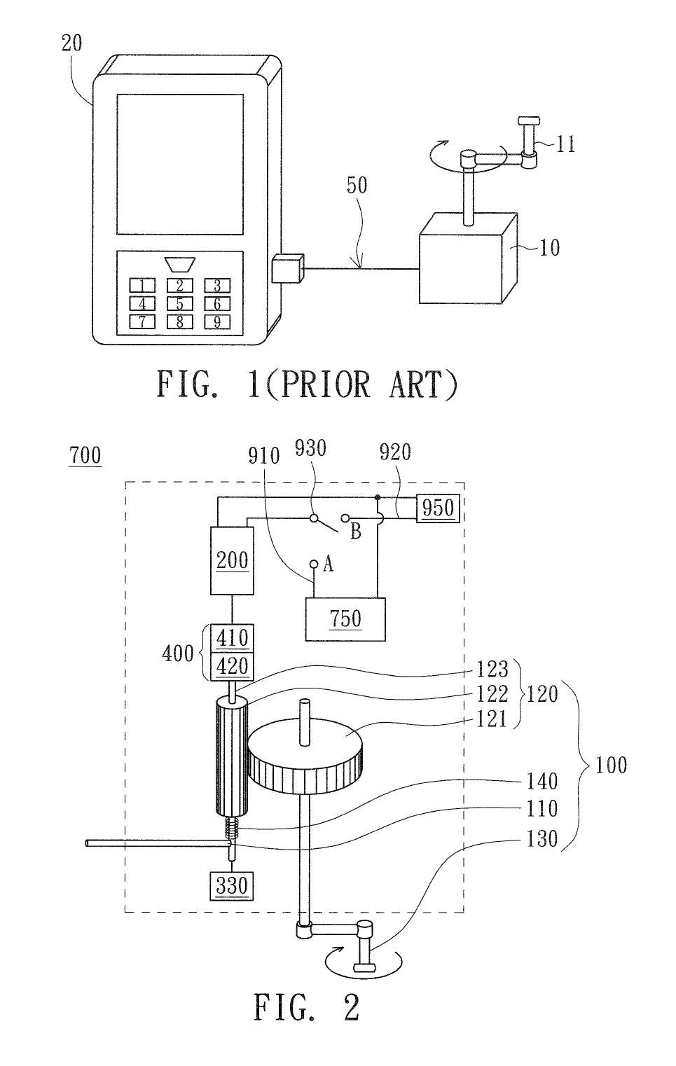

### DETAILED DESCRIPTION OF THE INVENTION

A generator and a communication device using the same are provided by the present invention. A vibrating motor in the generator works along with other components for providing electricity to the communication device immediately. In the embodiments of the present invention, a mobile phone is used as an example for illustrating the present invention. Unnecessary components are omitted in the drawings of the embodiments to clearly show the features of the present invention.

### First Embodiment

Referring to FIG. 2, a first embodiment of the present invention is illustrated. A mobile phone 700 includes a vibrating motor 200, an actuating device 100 and a weighting device 400. The vibrating motor 200 is for generating electricity or vibrating the mobile phone 700. The actuating device 100 is for driving the vibrating motor 200 to generate electricity. When the mobile phone 700 is in a first state, the vibrating motor 200 is driven for generating electricity by the actuating device 100 through the weighting device 400. When the mobile phone 700 is in a second state, the vibrating motor 200 is for vibrating the mobile phone 700.

As shown in FIG. 2, the weighting device 400 includes a first weighting unit 410 and a second weighting unit 420. The first weighting unit 410 is coupled to the vibrating motor 200. The second weighting unit 420 is disposed opposite to the first weighting unit 410 and coupled to the actuating device 100. The first weighting unit 410 and the second weighting unit 420 have opposite magnetic polarities, so the first weighting unit 410 and the second weighting unit 420 are engaged with each other by a magnetic force. Therefore, when the mobile phone 700 is in the first state, the second weighting unit 420 and the first weighting unit 410 are engaged with each other by the above-mentioned magnetic force for driving the vibrating motor 200 to generate electricity. When the mobile phone 700 is in the second state, the first weighting unit 410 is separated from the second weighting unit 420, and meanwhile the mobile phone 700 is capable of vibrating through the operation of the first weighting unit 410 driven by the vibrating motor 200.

As shown in FIG. 2, the actuating device 100 includes a transmission unit 120, a rotating portion 130, a buffer portion 140 and a switching portion 110. The transmission unit 120 includes a first gear 121, a second gear 122 and a transmission shaft 123. The first gear 121 is disposed on the same axis with the rotating portion 130. The second gear 122 is meshed with the first gear 121. The transmission shaft 123 is disposed on the same axis with the second gear 122 and coupled to the second weighting unit 420.

The buffer portion 140 is disposed at the transmission shaft 123 for mitigating the stress between the first weighting unit 410 and the second weighting unit 420 when the first weighting unit 410 is engaged with the second weighting unit 420, and for providing an elastic force to separate the first weighting unit 410 and the second weighting unit 420. The switching portion 110 is coupled to the transmission shaft 123 for switching the mobile phone 700 to be the first state or the second state. In the present embodiment of the invention, the buffer portion 140 is a spring. The transmission shaft 123 is inserted into the spring, and two ends of the spring are connected to the second gear 122 and the switching portion 110, respectively.

In addition, in the present embodiment of the invention, the tooth number of the first gear 121 is greater than the tooth number of the second gear 122, so that the vibrating motor 200 as a generator has higher rotation speed and the electricity is generated more effectively. Moreover, the face width of the second gear 122 is larger than the face width of the firs gear 121. Therefore, the arrangement of the first gear 121 is more flexible.

As shown in FIG. 2, the mobile phone 700 further includes a first circuit 910, a second circuit 920, switches 330 and 930, and a vibration controller 950. The switch 330 is electrically coupled to the transmission shaft 123 and the switch 930. The switch 930 is connected to a terminal A or a terminal B alternatively. In other words, the first circuit 910 and the second circuit 920 are selectively coupled to the vibrating motor 200 by switching the switch 930. The vibration controller 950 is coupled to the vibrating motor 200. When the mobile phone 700 is in the first state, the switch 930 is connected to the terminal A by switching the switch 330, so that the electricity is transmitted to other component 750 of the mobile phone 700 through the first circuit 910. When the mobile phone 700 is in the second state, the switch 930 is connected to the terminal B by switching the switch 330, so that a vibrating signal is transmitted to the vibration controller 950 of the mobile phone 700 through the second circuit 920. The vibrating motor 200 is then controlled to vibrate by the vibration controller 950.

To conclude comprehensively, when the mobile phone 700 needs to be charged, the mobile phone 700 is first switched to the first state by the switching portion 110. Then, the transmission shaft 123 is driven by the switching portion 110, so that the switch 330 is switched by the operation of the transmission shaft 123. Thus, the switch 930 is connected to the terminal A for electrically connecting the first circuit 910. In addition, through the operation of the transmission shaft 123, the second weighting unit 420 and the first weighting unit 410 are engaged with each other by the magnetic force therebetween and the rotation of the first weighting unit 410 and the second weighting unit 420. When the rotating portion 130 is rotated by a user, the first gear 121 is driven to rotate. After that, the second gear 122 meshed with the first gear 121 is driven by the first gear 121 to drive the transmission shaft 123 to rotate, so that the second weighting unit 420 and the first weighting unit 410 rotate together. As a result, the vibrating motor 200 is driven to generate electricity by the first weighting unit 410, and the electricity is transmitted to other component 750 of the mobile phone 700 through the terminal A and the first circuit 910.

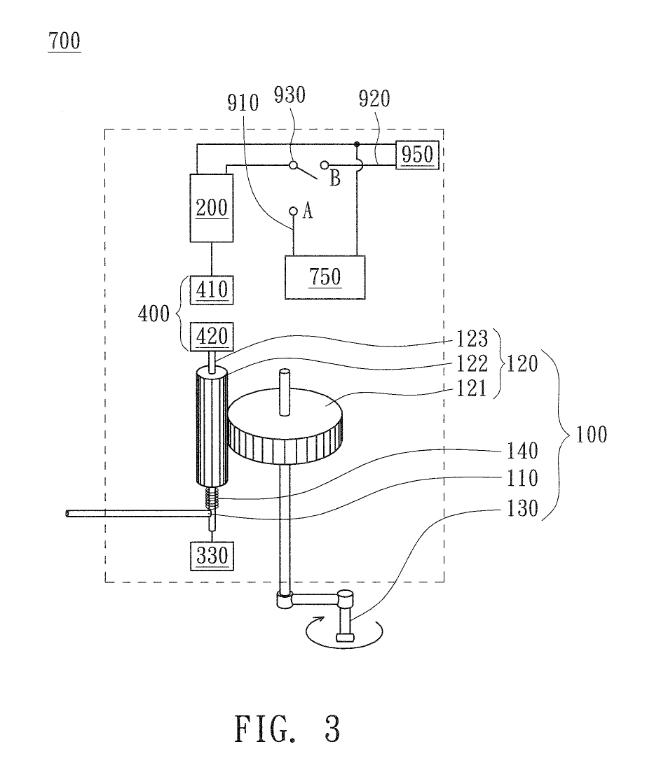

Referring to FIG. 3, the mobile phone in FIG. 2 in the second state is illustrated. When the mobile phone 700 is in the second state, the first weighting unit 410 is separated from the second weighting unit 420. Meanwhile, the switch 330 is switched by the switching portion 110, so that the switch 930 is connected to the terminal B for electrically conducting the second circuit 920. The vibrating signal is transmitted to the vibration controller 950 through the second circuit 920, so that the vibrating motor 200 is controlled to drive the first weighting unit 410 by the vibration controller 950 for vibrating the mobile phone 700. In other words, the vibrating motor 200 is for vibrating the mobile phone 700 in the second state.

### Second Embodiment

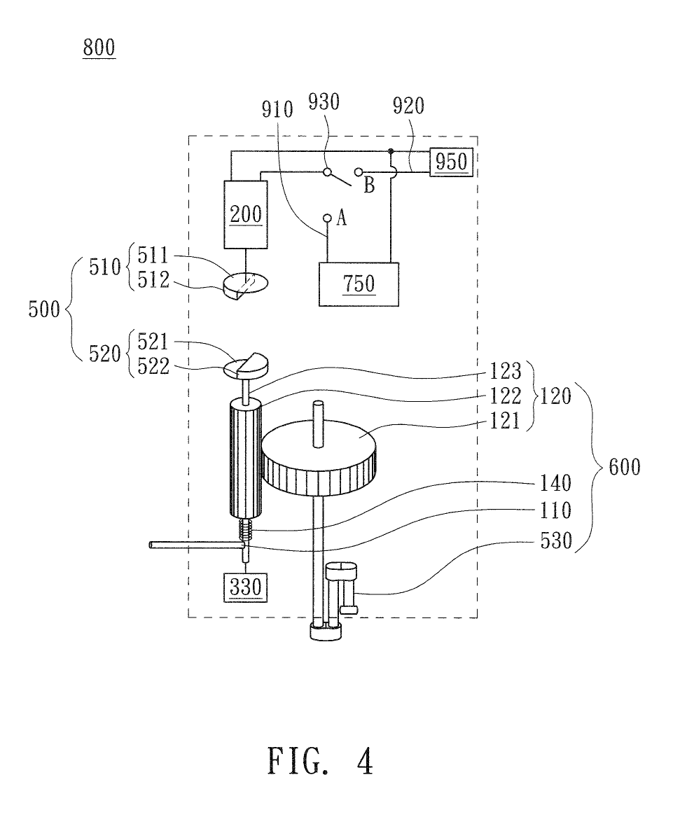

Referring to FIG. 4, a second embodiment of the present invention is illustrated. The present embodiment of the invention differs from the first embodiment in the design of the first weighting unit and the second weighting unit of the weighting device. In the first embodiment, the first weighting unit 410 and the second weighting unit 420 of the weighting device 400 are engaged with each other through the magnetic force. In the present embodiment of the invention, the first weighting unit 510 and the second weighting unit 520 of the weighting device 500 are engaged with each other through complementary shapes. However, it is to be understood that the invention is not limited thereto. For example, the first weighting unit and the second weighting unit can be engaged with each other through both a magnetic force and complementary shapes.

In the present embodiment of the invention, the first weighting unit 510 has a first weighting plate 511 and a first bump 512 disposed on the first weighting plate 511. The second weighting unit 520 has a second weighting plate 521 and a second bump 522 disposed on the second weighting plate 521.

The shape of the first bump 512 and the shape of the second bump 522 are complementary, and the first bump 512 and the second bump 522 are disposed correspondingly. Therefore, the first bump 512 is engaged with the second bump 522 when the mobile phone 800 is in a first state (not shown in FIG. 4), that is to say, in the state of charging. As a result, the vibrating motor 200 is driven for generating electricity by the actuating device 600. In addition, as shown in FIG. 4, when the mobile phone 800 is in a second state, the first bump 512 of the first weighting unit 510 is separated from the second bump 522 of the second weighting unit 520. At this time, the first weighting unit 410 is driven by the vibrating motor 200 for vibrating the mobile phone 800.

Furthermore, as shown in FIG. 4, the rotating portion 530 of the actuating device 600 of the present embodiment of the invention can be folded and stored in the mobile phone 800 for conveniently carrying.

According to the generator and the communication device using the same disclosed in the above embodiments of the invention, the vibrating motor included in the communication device, such as the mobile phone, can be used for generating electricity. As a result, it is not necessary to bring the connecting wire and the external charger which occupy large space. In addition, the communication device can be charged immediately when the battery of the communication device is getting low or when the communication is needed. Moreover, the internal arrangement of the communication device only needs to be modified slightly. The cost of the generator of the embodiments of the invention is lower than that of the conventional external charger.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A generator disposed in an electronic device capable of vibrating, the generator comprising:
a vibrating motor for generating electricity or vibrating the electronic device;
an actuating device for driving the vibrating motor to generate electricity; and
a weighting device, comprising:
a first weighing unit coupled to the vibrating motor; and
a second weighting unit disposed opposite to the first weighting unit and coupled to the actuating device;
wherein the second weighting unit is engaged with the first weighting unit when the generator is in a first state, and meanwhile the vibrating motor is driven for generating electricity by the actuating device due to the engagement of the first weighting unit and the second weighting unit;
wherein the first weighting unit is separated from the second weighting unit when the generator is in a second state, and meanwhile the electronic device is capable of vibrating through the operation of the first weighting unit driven by the vibrating motor.

2. The generator according to claim 1, wherein the actuating device comprises:
a transmission unit coupled to the second weighting unit of the weighting device; and
a rotating portion coupled to the transmission unit, wherein the weighting device is driven by the rotating portion when the generator is in the first state, so that the vibrating motor is driven for generating electricity.

3. The generator according to claim 2, wherein the transmission unit comprises:
a first gear disposed on the same axis with the rotating portion, wherein the first gear is driven by the rotating portion when the generator is in the first state;
a second gear meshed with the first gear, wherein the second gear is driven to rotate by the first gear when the first gear rotates; and
a transmission shaft disposed on the same axis with the second gear and coupled to the second weighting unit, wherein the transmission shaft is driven to rotate by the second gear when the second gear rotates, so that the second weighting unit rotates.

4. The generator according to claim 3, wherein the tooth number of the first gear is greater than the tooth number of the second gear.

5. The generator according to claim 3, wherein the face width of the second gear is larger than the face width of the first gear.

6. The generator according to claim 3, wherein the actuating device further comprises:
a buffer portion disposed at the transmission shaft for mitigating the stress between the first weighting unit and the second weighting unit when the first weighting unit is engaged with the second weighting unit.

7. The generator according to claim 6, wherein the actuating device further comprises:
a switching portion coupled to the transmission shaft for switching the generator to be the first state or the second state, wherein when the switching portion is switched, the transmission shaft is driven by the switching portion, so that the second weighting unit and the first weighting unit are engaged with each other or separated from each other.

8. The generator according to claim 7, wherein the buffer portion is a spring and two ends of the spring are connected to the second gear and the switching portion, respectively.

9. The generator according to claim 1, further comprising:
a vibration controller coupled to the vibrating motor;
a first circuit selectively coupled to the vibrating motor, wherein the electricity generated by the vibrating motor is transmitted to the electronic device through the first circuit when the generator is in the first state; and
a second circuit coupled to the vibration controller and selectively coupled to the vibrating motor, wherein a vibration signal is transmitted to the vibration controller through the second circuit when the generator is in the second state, so that the vibrating motor is controlled to vibrate by the vibration controller.

10. The generator according to claim 9, further comprising:
a switch electrically coupled to the transmission shaft, wherein when the generator is switched to be the first state or the second state by the switching portion, the transmission shaft is driven by the switching portion to switch the switch for electrically conducting the first circuit or the second circuit.

11. The generator according to claim 1, wherein the first weighting unit and the second weighting unit have opposite magnetic polarities, so that the first weighting unit and the second weighting unit are engaged with each other by a magnetic force.

12. The generator according to claim 1, wherein the first weighting unit has a first weighting plate and a first bump disposed on the first weighting plate, the second weighting unit has a second weighting plate and a second bump disposed on the second weighting plate, the first bump and the second bump have complementary shapes and are disposed correspondingly, and the first bump is engaged with the second bump when the generator is in the first state.

13. A communication device, comprising:
a vibrating motor for generating electricity or vibrating the communication device; and
an actuating device for driving the vibrating motor to generate electricity;
wherein the vibrating motor is driven for generating electricity by the actuating device when the communication device is in a first state, and the vibrating motor is for vibrating the communication device when the communication device is in a second state.

14. The communication device according to claim 13, further comprising:
a weighting device, comprising:
a first weighting unit coupled to the vibrating motor; and
a second weighting unit disposed opposite to the first weighting unit and coupled to the actuating device;
wherein the second weighting unit is engaged with the first weighting unit when the communication device is in the first state, and meanwhile the vibrating motor is driven for generating electricity by the actuating device due to the engagement of the first weighting unit and the second weighting unit;
wherein the first weighting unit is separated from the second weighting unit when the communication device is in the second state, and meanwhile the communication device is capable of vibrating through the operation of the first weighting unit driven by the vibrating motor.

15. The communication device according to claim 14, wherein the first weighting unit and the second weighting unit have opposite magnetic polarities, so that the first weighting unit and the second weighting are engaged with each other by a magnetic force.

16. The communication device according to claim 14, wherein the first weighting unit has a first weighting plate and a first bump disposed on the first weighting plate, the second weighting unit has a second weighting plate and a second bump disposed on the second weighting plate, the first bump and the second bump have complementary shapes and are disposed correspondingly, and the first bump is engaged with the second bump when the communication device is in the first state.

17. The communication device according to claim 14, wherein the actuating device comprises:
a transmission unit coupled to the second weighting unit of the weighting device; and
a rotating portion coupled to the transmission unit, wherein the weighting device is driven by the rotating portion when the communication device is in the first state, so that the vibrating motor is driven for generating electricity.

18. The communication device according to claim 17, wherein the transmission unit comprises:
a first gear disposed on the same axis with the rotating portion, wherein the first gear is driven by the rotating portion when the communication device is in the first state;
a second gear meshed with the first gear, wherein the second gear is driven to rotate by the first gear when the first gear rotates; and
a transmission shaft disposed on the same axis with the second gear and coupled to the second weighting unit, wherein the transmission shaft is driven to rotate by the second gear when the second gear rotates, so that the second weighting unit rotates.

19. The communication device according to claim 18, wherein the tooth number of the first gear is greater than the tooth number of the second gear.

20. The communication device according to claim 18, wherein the face width of the second gear is larger than the face width of the first gear.

21. The communication device according to claim 18, wherein the actuating device further comprises:
a buffer portion disposed at the transmission shaft for mitigating the stress between the first weighting unit and the second weighting unit when the first weighting unit is engaged with the second weighting unit.

22. The communication device according to claim 21, wherein the actuating device further comprises:
a switching portion coupled to the transmission shaft for switching the communication device to be the first state or the second state, wherein when the switching portion is switched, the transmission shaft is driven by the switching portion, so that the second weighting unit and the first weighting unit are engaged with each other or separated from each other.

23. The communication device according to claim 22, wherein the buffer portion is a spring and two ends of the spring are connected to the second gear and the switching portion, respectively.

24. The communication device according to claim 13, further comprising:
a vibration controller coupled to the vibrating motor;
a first circuit selectively coupled to the vibrating motor, wherein the electricity generated by the vibrating motor is transmitted to the communication device through the first circuit when the communication device is in the first state; and
a second circuit coupled to the vibration controller and selectively coupled to the vibrating motor, wherein a vibration signal is transmitted to the vibration controller through the second circuit when the communication device is in the second state, so that the vibrating motor is controlled to vibrate by the vibration controller.

25. The communication device according to claim 24, further comprising:
a switch electrically coupled to the transmission shaft, wherein when the generate is switched to be the first state or the second state by the switching portion, the transmission shaft is driven by the switching portion to switch the switch for electrically conducting the first circuit or the second circuit.
